(19) United States
(12) Patent Application Publication
(10) Pub. No.: US 2010/0260392 A1
(43) Pub. Date: Oct. 14, 2010

(54) CONSISTENCY METRIC BASED IMAGE REGISTRATION

(75) Inventors: Rafael Wiemker, Kisdorf (DE); Sven Kabus, Hamburg (DE); Thomas Buelow, Grosshansdorf (DE); Roland Opfer, Hamburg (DE)

Correspondence Address: PHILIPS INTELLECTUAL PROPERTY & STANDARDS, P. O. Box 3001, BRIARCLIFF MANOR, NY, 10510, US

(73) Assignee: KONINKLIJKE PHILIPS ELECTRONICS N.V., EINDHOVEN (NL)

(21) Appl. No.: 12/746,179

(22) PCT Filed: Dec. 12, 2008
(86) PCT No.: PCT/IB08/55254

§ 371 Date: Jun. 4, 2010

Related U.S. Application Data
(60) Provisional application No. 61/014,464, filed on Dec. 18, 2007.

(51) Int. Cl. G06T 7/00; G06K 9/60

(52) U.S. Cl. 382/128; 382/190

(57) ABSTRACT

A method includes registering a first sub-portion of a first image with a corresponding second sub-portion of a second image, and registering the second sub-portion of the second image with a corresponding third sub-portion of the first image. The first sub-portion encompasses a first object of interest, and the third sub-portion encompasses a third object of interest. The method further includes reducing a size of the first sub-portion when the first and third objects of interest are substantially similar. The method further includes repeating the steps of registering the first sub-portion, registering the second sub-portion, and reducing the size of the first sub-portion until the first and third objects are not substantially similar.

The following generally relates to registering medical imaging images based on a consistency metric, and finds particular application to computed tomography (CT). However, it also amenable to other medical imaging applications and to non-medical imaging applications.

Medical imaging modalities such as computed tomography (CT), magnetic resonance (MR), ultrasound (US), single photon emission computed tomography (SPECT), positron emission tomography (PET), and x-ray can play an important role in the diagnosis of diseases such as cancer. For instance, they can be used to non-invasively obtain information indicative of physiological tissue in the body, and such information can be used to facilitate determining whether a tumor is benign or malignant. Such non-invasive techniques typically are less risky and costly than an invasive technique such as a biopsy. In addition, for relatively small tumors, such as tumors 10 millimeters or less, it may be relatively difficult to ascertain whether a biopsy needle hit the tumor.

More particularly, images such as CT images can be used to perform a differential diagnosis. By way of example, two CT images, both including information indicative of the same tumor, but generated from data acquired at a different moment in time, for example one to six months apart, can be used to access tumor growth over time by comparing the size of the tumor in the first image with the size of the same tumor in the second image. Generally, an increase in tumor size greater than a pre-set threshold (e.g., 20%) indicates that the tumor is malignant, whereas non-growth or growth less than the threshold indicates that the tumor is benign.

Unfortunately, when comparing such images some organs such as the lung may not be in the same position in both images due to differences in patient setup. As a consequence, spatial registration between the images may be problematic. For example, the clinician may have to manually review a number of images (e.g., 200 or more) in a second set of images, generated with data acquired in a second scan, in order to find an image that shows the tumor for comparison with a first image from a first scan. Even after spatial registration, structures inside the lungs such as the tumor may not be in the same location due to differences in the respiratory state.

With automated tumor growth assessment, the position of the tumor in a first image is automatically matched to a position in a second image. Full registration of the first image to the second image may be possible using an elastic registration technique, which allows for imaging warping even though there may be differences in patient setup, anatomical interval changes, and differences in respiratory state. Unfortunately, elastic registration may warp the tumor in the image, and thus may change the size of the tumor, which is problematic when performing a differential diagnosis.

Aspects of the present application address the above-referenced matters and others.

According to one aspect, a method includes registering a first sub-portion of a first image with a corresponding second sub-portion of a second image, and registering the second sub-portion of the second image with a corresponding third sub-portion of the first image. The first sub-portion encompasses a first object of interest, and the third sub-portion encompasses a third object of interest. The method further includes reducing a size of the first sub-portion when the first and third objects of interest are substantially similar. The method further includes repeating the steps of registering the first sub-portion, registering the second sub-portion, and reducing the size of the first sub-portion until the first and third objects are not substantially similar.

According to another aspect, an image registration system includes a registration component that registers a first volume of interest of a first image with a corresponding second volume of interest of a second image and reverse registers the second volume of interest of the second image with a corresponding third volume of interest of the first image. The first volume of interest includes a first object of interest, and the third volume of interest includes a third object of interest. The system further includes a consistency determining component that determines a consistency value between the first and third objects of interest. The consistency value is indicative of the similarly between the first and third objects of interest. The system further includes a decision component that determines whether a size of the first volume of interest is reduced based on the consistency value.

According to another aspect, a method includes iteratively reducing a size of a volume of interest in a first image until a consistency error between a forward and a reverse registration of the volume of interest between a first and second image becomes greater than a consistency error threshold. The method further includes presenting a first volume of interest of the first image and a second volume of interest of the second image, wherein the first and second volumes of interest have a size that corresponds to a size of the volume of interest at which the consistency error between the forward and the reverse registration was less than the consistency error threshold.

The invention may take form in various components and arrangements of components, and in various steps and arrangements of steps. The drawings are only for purposes of illustrating the preferred embodiments and are not to be construed as limiting the invention.

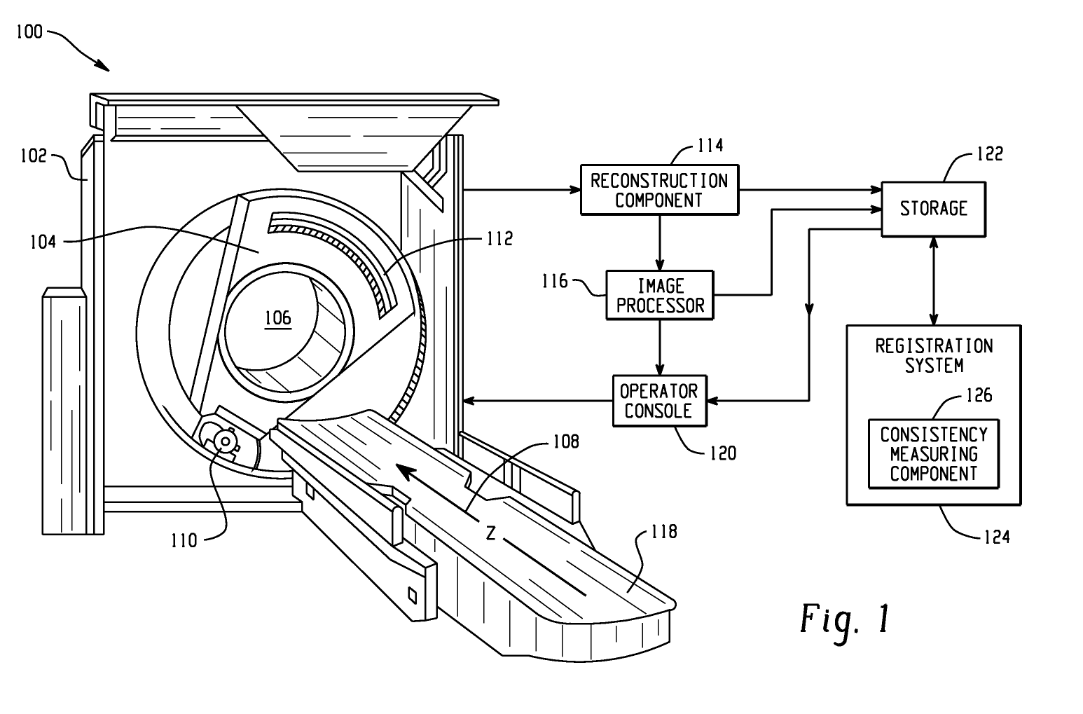

FIG. 1 illustrates a medical imaging apparatus.

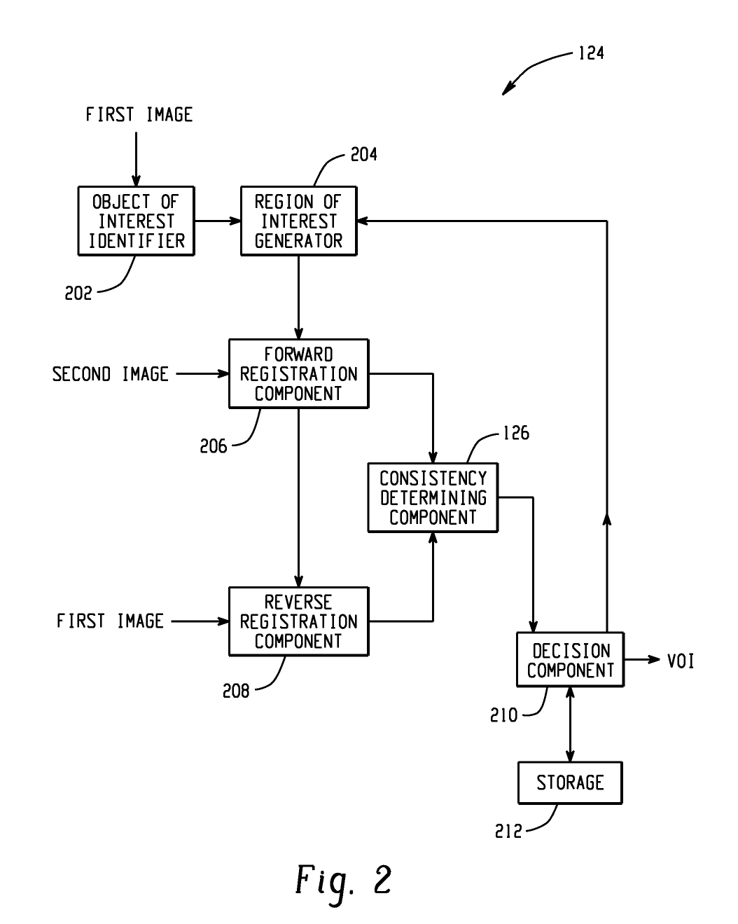

FIG. 2 illustrates an example image registration component.

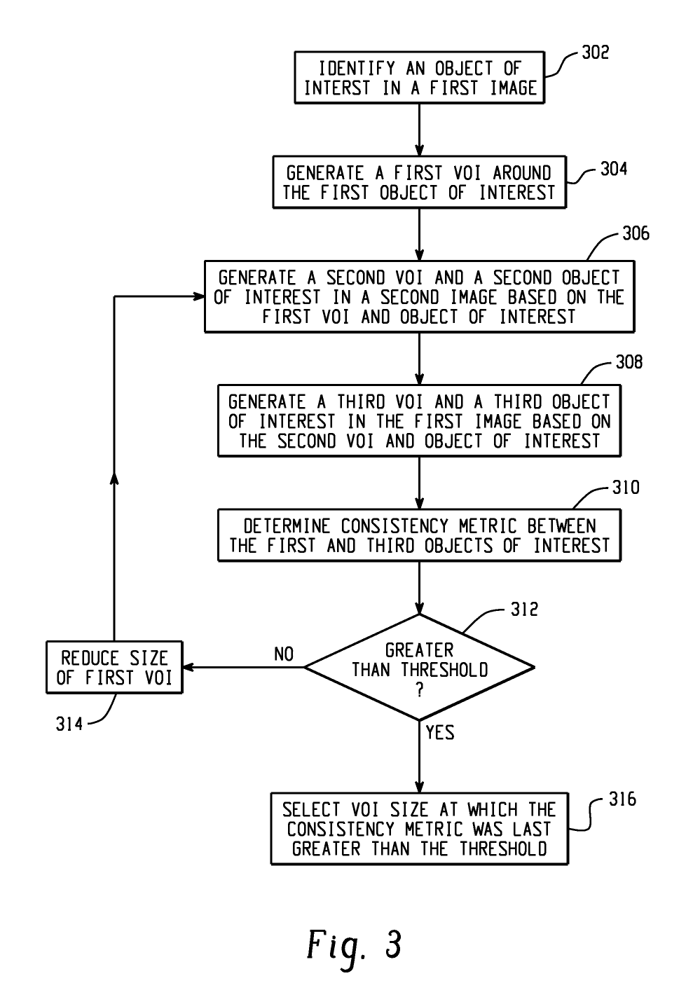

FIG. 3 illustrates a method.

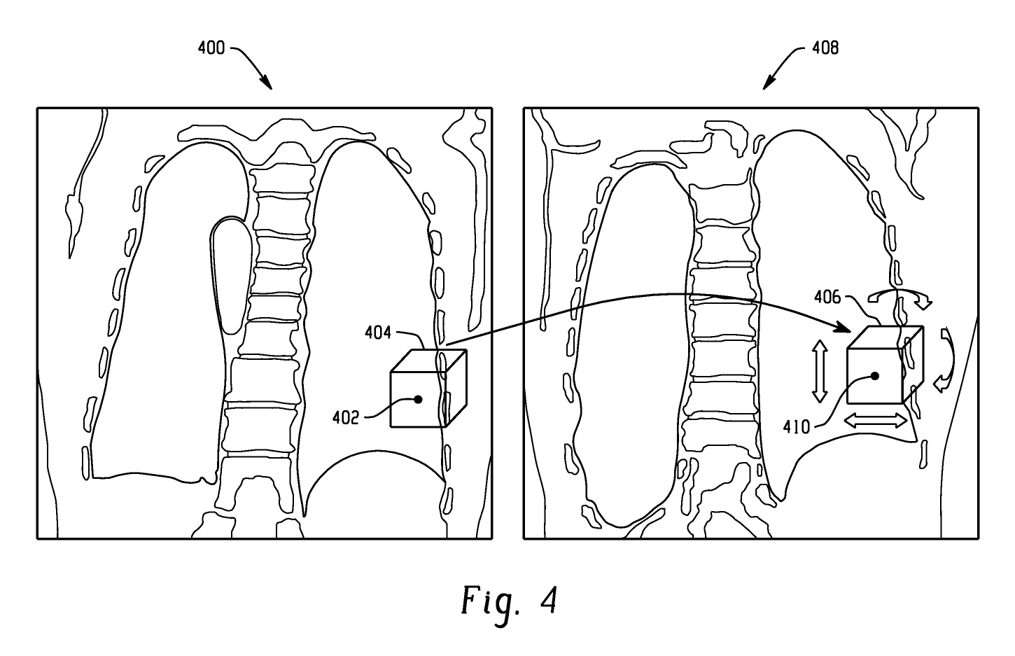

FIG. 4 illustrates an initial registration of a VOI in two images.

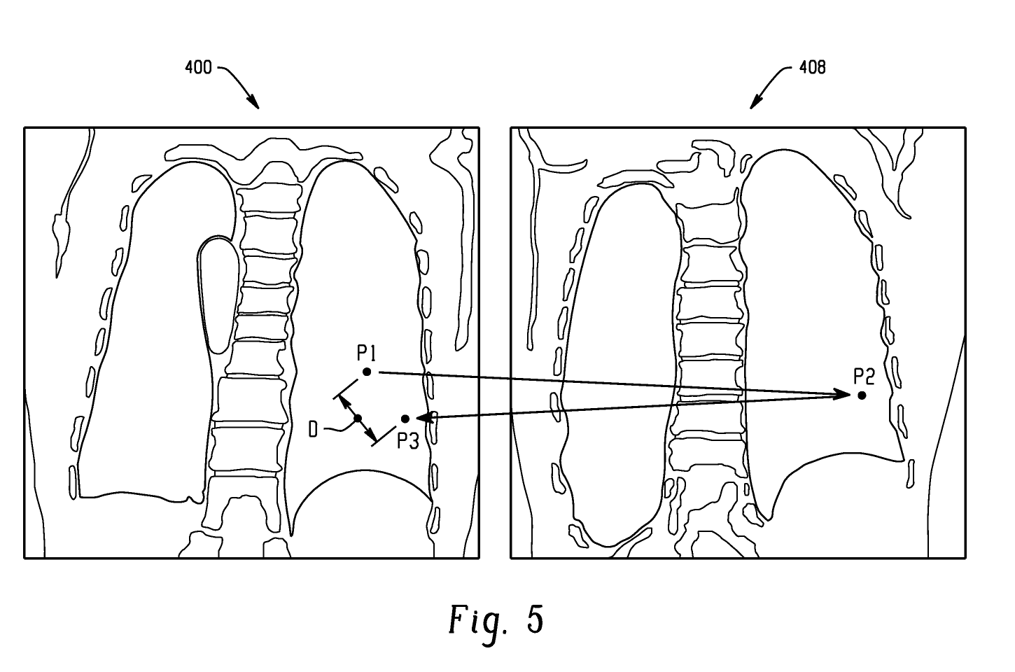

FIG. 5 illustrates a consistency check between the registered VOI's.

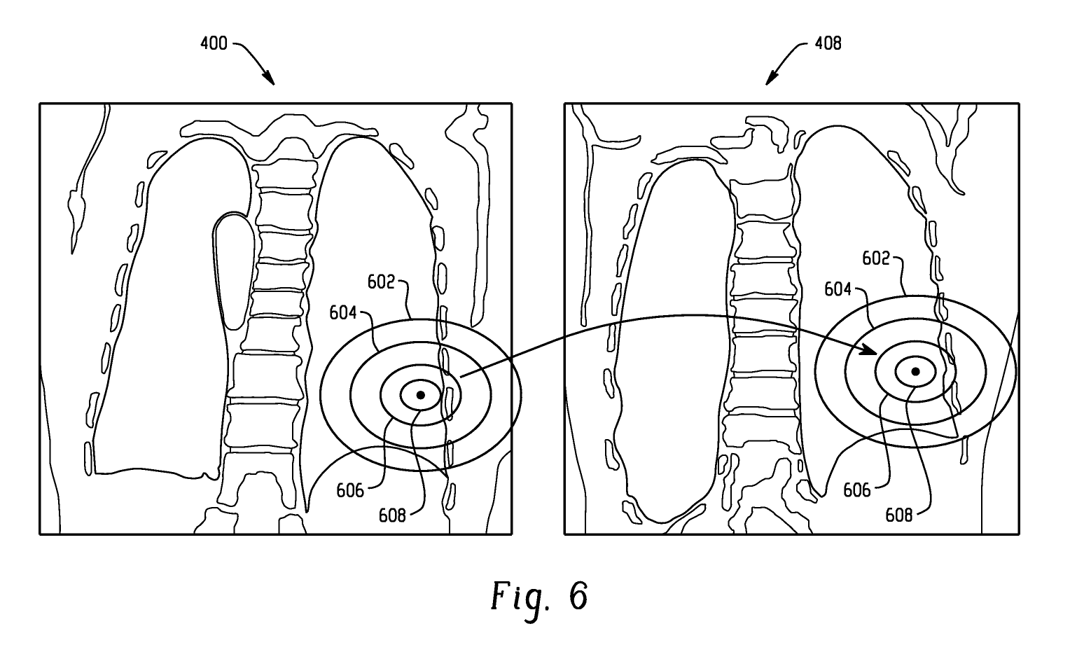

FIG. 6 illustrates a refined registration of the VOI in two images.

Initially referring to FIG. 1, a computed tomography (CT) scanner 100 includes a stationary gantry 102, which is stationary in the sense that it is generally stationary during scanning. However, the stationary gantry 102 may be configured to tilt and/or otherwise be moved.

The computed tomography (CT) system 100 also includes a rotating gantry 104, which is rotatably coupled to the stationary gantry 102. The rotating gantry 104 rotates around an examination region 106 about a longitudinal or z-axis 108.

A radiation source 110, such as an x-ray tube, is supported by and rotates with the rotating gantry 104 around the examination region 106. The radiation source 110 emits generally fan, wedge, or cone shaped radiation that traverses the examination region 106. A fourth generation system is also contemplated.

A radiation sensitive detector array 112 detects photons emitted by the radiation source 110 that traverse the examination region 106 and generates projection data indicative of the detected radiation. The illustrated radiation sensitive detector array 112 includes multiple rows of radiation sensitive photo sensor that extend in the z-axis direction, and multiple columns of radiation sensitive photo sensors that extend in a traverse direction. A single row detector array configuration is also contemplated.

A reconstructor 114 reconstructs the projection data from the detectors to generate volumetric image data indicative of the interior anatomy of the patient.

An image processor 116 processes the volumetric image data generated by the reconstructor 114 for display in human readable form.

A patient support 118, such as a couch, supports a patient in the examination region 106. The patient support 118 is movable along the z-axis 108 in coordination with the rotation of the rotating gantry 104 to facilitate helical, axial, or other desired scanning trajectories.

A general purpose computing system 120 serves as an operator console. The operator console 120 includes human readable output devices such as a display and/or printer and input devices such as a keyboard and/or mouse. Software resident on the console 120 allows the operator to control the operation of the system 100, for example, by allowing the operator to select a scan protocol, initiate and terminate scanning, view and/or manipulate the volumetric image data, and/or otherwise interact with the system 100.

A storage component 122 can be used to store the volumetric image data generated by the reconstructor 114 and/or the one or more images generated by the image processor 116.

A registration system 124 is used to register data acquired at different moments in time based on a consistency metric. A consistency determining component 126 determines the consistency metric. As described in greater detail below, the registration system 124 performs an iterative registration in which a size of a sub-portion of an image, such as a region of interest (ROI) or a volume of interest (VOI), encompassing an object of interest, in the registered images is optimized based on the consistency metric. In one instance, the optimization ensures consistent unambiguous matching of the object of interest between images, while reducing surrounding extraneous anatomical structures.

FIG. 2 further illustrates the registration component 124. For the following discussion, note that the first image is generated using data acquired at a first time and the second image is generated with data acquired at a second time, which may be weeks, months, etc. after the first time.

An object of interest identifier 202 identifies a first object of interest in the first image. In one instance, the object of interest identifier 202 identifies the first object of interest based on user input. For example, the user may use a mouse, keyboard, and/or other input device to select the first object of interest in the first image.

A volume of interest generator 204 generates a first volume of interest (VOI) around the identified first object of interest in the first image. In one instance, the initial shape and size of the first VOI is pre-configured. Suitable shapes may dependent on the object of interest and/or the location of the object of interest in the body. The initial size is set sufficiently large to include enough contextual information for unambiguous matching of the VOI to another image. User defined shapes and/or sizes are also contemplated. In addition, the VOI may be restricted to one or more particular organs.

A forward registration component 206 registers the first object of interest and the first VOI in the first image with a corresponding second object of interest and second VOI in the second image. The second object of interest represents structure in the second image believed to correspond to the first object of interest in the first image. The first VOI provides context information that facilitates matching the first and second objects of interest.

A volume preserving registration such as a rigid registration is used in the illustrated example. The rigid registration is computed by optimizing a similarity measure between first image values in the first VOI and second image values in the second VOI. This may include computing, for each voxel, a difference between the first image and the second image. For optimization, the second VOI is varied in position, orientation and/or scale until optimal similarity is reached between the first object of interest and the second object of interest.

In the illustrated embodiment, the similarity measure is computed between the first and second VOI areas only. The similarity measure can be based on correlation, root mean square deviation, mutual information, etc. For smoothness, the similarity measure can be summed up from (e.g. Gaussian-) weighted contributions, with weights decreasing from center to periphery of the VOI. The optimization technique can be exhaustive, stochastic, Gauss-Newton, etc.

A reverse registration component 208 registers the second object of interest in the second image with a corresponding third object of interest in the first image, with the second VOI providing context information that facilitates such matching. The third object of interest represents structure in the first image believed to correspond to the second object of interest in the second image and, thus, represents structure in the first image believed to be the first object of interest. With an unambiguous registration, the resulting third object of interest should substantially coincide with the first object of interest. The second VOI provides context information that facilitates matching the second and third objects of interest. Again, a volume preserving registration such as a rigid registration is used.

The consistency determining component 126 measure a consistency between the first object of interest and the third object of interest in the first image. In the illustrated embodiment, the consistency metric is computed by determining a distance such as the Euclidean distance between the first object of interest and the third object of interest. Equation 1 illustrates an example algorithm for computing a Euclidean distance, normalized by the total number of voxels, between the first and third object of interests.

$$D = {\sum }_{i} \sqrt{{( {x}_{i 1} - {x}_{i 0} )}^{2} + {( {y}_{i 1} - {y}_{i 0} )}^{2} + {( {z}_{i 1} - {z}_{i 0} )}^{2}} , \qquad Equation 1$$

where D represents the Euclidian distance, i represents the total number of voxels, and x, y and z represent the coordinates of the voxels.

It is noted that the consistency metric does not guarantee, in a strict sense, that erroneous matches can be identified. Theoretically, an erroneous yet backward/forward-consistent match can occur. However, the consistency metric may provide a sufficient indication of an erroneous match.

A decision component 210 decides, based on the consistency metric, whether the size of the VOI is optimized in the sense that the VIO generally is the smallest size in which the third object of interest can be unambiguously matched with the first object of interest. In one instance, the decision component 210 basis the decision on whether the consistency metric is greater or less than a pre-set consistency threshold value.

If the consistency metric is less than the threshold, the decision component 210 invokes the region of interest generator 204 to shrink or reduce the size of the first VOI. In one instance, the VOI is reduced in volume by a pre-set percentage, for example, 30%. In another instance, the VOI is reduced in volume by a pre-set volume. Other reductions are also contemplated. However, when the consistency metric becomes greater than the threshold, the decision component 210 identifies the last VOI in which the consistency metric was less than the threshold as the optimal VOI.

A storage component 212 stores VOI's. For example, when the consistency metric is less than the threshold, the VOI is stored in the storage component 212. As such, the current VOI is available if the consistency metric for the next VOI is greater than the consistency threshold value.

Variations are discussed.

In the illustrated embodiment, the user identifies the first object of interest. In an alternative embodiment, the object of interest identifier 202 automatically identifies a candidate object of interest in the first image based on one or more characteristics of a desired type of tissue. Such identification may be based on grey level values and/or other characteristics in the first image.

In the illustrated embodiment, a VOI of interest is generated around the object of interest. In an alternative embodiment, a region of interest (ROI) is used. Likewise, the initial ROI size is sufficiently large and the final ROI size is such that it provides a consistent unambiguous matching, while reducing extraneous anatomical structures.

The VOI may be variously shaped. For example, suitable shapes include, but are not limited to, cubical, cylindrical, spherical, ellipsoidal, and/or other shape. When a ROI is used instead of a VOI, two dimensional counterpart shapes can be used.

In the illustrated embodiment, the initial VOI is set to be relatively large and is then reduced in size until the consistency metric became greater than the consistency threshold. In another embodiment, the initial VOI (or ROI) may be set to be relatively small and then increased in size until the consistency metric became less than the consistency threshold.

In the illustrated embodiment, a rigid registration is used to preserve the size of the structure in the VOI. In another embodiment, an elastic registration is used. In one instance, a set of constraints is used along with the elastic registration so that the object of interest is not warped.

It is to be appreciated that the registration system 124 may be part of a medical imaging system (as shown) or part of a workstation separate from a medical imaging system.

Operation is now described in connection with FIGS. 3-6.

At 302, a first object of interest is identified in a first image. As noted above, this may be achieved via a manual or automatic approach.

At 304, a first VOI (or ROI) is generated around the first object of interest. For the selected object of interest, the algorithm foresees to start with a relatively large fixed sized VOI in order to capture enough anatomical context for unambiguous registration of the first VOI with a VOI in another image.

FIG. 4 shows an example first image 400 with a first object of interest 402 and a first VOI 404. In this example, the first VOI 404 is cube shaped.

Returning to FIG. 3, at 306 a corresponding second VOI and object of interest are matched in the second image.

Turning back to FIG. 4, a corresponding VOI 406 is translated, rotated, and/or scaled until the VOI 406 in a second image 408 optimally resembles the VOI 404 in the first image 400 based on a similarity measurement. The matching algorithm identifies the most likely corresponding object of interest 410 in the second image 408. As noted above, the registration of the VOI 402 in the second image 408 may be rigid to preserve the shape of the anatomical volume and not compromise tumor growth assessment.

Returning to FIG. 3, at 308 a reverse registration is carried out. For the reverse registration, a third VOI and object of interest are identified in the first image based on the second VOI and object of interest in the second image. As noted above, the third object of interest should match the first object of interest.

At 310, a consistency metric or error between the first object of interest and the third object of interest is determined. In the illustrated embodiment, the consistency metric is the Euclidian distance between the first and third objects of interest, which provides an objective measure for the match between the first and third objects of interest.

FIG. 5 shows the first object of interest 402 (“P1”), the second object of interest 410 (“P2”) and a third object of interest (“P3”), and a distance (“D”) between the P1 and P3.

Returning to FIG. 3, at 312 the consistency metric is compared against a pre-set threshold value. If the consistency metric is less than the threshold, then the first VOI is decreased in size AT 314, and acts 306 to 312 are performed again. When the consistency metric becomes greater than the threshold, then at 316 the size of the VOI at which the consistency metric was last less than the threshold is selected.

As such, the VOI size is gradually or iteratively decreased until so much context information is lost that the matchings are no longer mutually inverse, and thus the consistency error becomes too large. In other words, if the VOI size becomes so small that the matching of the VOIs starts to become ambiguous, then the matching between forward and backward registrations will become inconsistent.

FIG. 6 shows an example in which an initial VOI size 602 is iteratively decreased through VOI sizes 604 and 606, until an optimal size 608 is obtained, based on the consistency metric. Note that in FIG. 6 a cylindrically shaped VOI is employed, whereas the shape of the VOI in FIGS. 4 and 5 is cubical.

Returning to FIG. 3, at 316 the VOI that yielded the last still acceptable consistency error is presented to the user, which may be a radiologist or automatic growth assessment algorithm, for example. As such, the process is aborted when the matching consistency error increases above a tolerable level, and the matching solution corresponding to the finest VOI that still yields consistent matching is presented.

In general, the size of the final VOI is desired to be as small as possible, because the most important task is the matching of the object of interest, which should not be compromised by other structures, such as the lung wall, ribs, vessels, or organs, which may have changed position relative to the object of interest between the two image volumes. On the other hand, if the VOI size is chosen too small, then an unambiguous matching of the two VOIs is no longer possible, because too much context information is lost. The general underlying idea is that the VOI size should be large enough to establish a consistent unambiguous matching, but small enough to match the location of a selected structure to the corresponding location in the other image as exact as possible without distraction by further away anatomical structures.

The embodiments herein were described in connection with a computed tomography medical imaging applications. However, it is to be understood that the invention may additionally or alternatively be employed with other medical imaging applications and/or non-medical imaging applications in which it is desirable to capture spectral aspects of radiation.

The invention has been described with reference to the preferred embodiments. Modifications and alterations may occur to others upon reading and understanding the preceding detailed description. It is intended that the invention be constructed as including all such modifications and alterations insofar as they come within the scope of the appended claims or the equivalents thereof.

1. A method, comprising:
registering a first sub-portion of a first image with a corresponding second sub-portion of a second image, wherein the first sub-portion encompasses a first object of interest;
registering the second sub-portion of the second image with a corresponding third sub-portion of the first image, wherein the third sub-portion encompasses a third object of interest;
reducing a size of the first sub-portion when the first and third objects of interest are substantially similar; and
repeating the steps of registering the first sub-portion, registering the second sub-portion, and reducing the size of the first sub-portion until the first and third objects are not substantially similar.

2. The method of claim 1, further including determining a consistency metric indicative of the similarly between the first and third objects of interest, and repeating the steps of registering the first sub-portion, registering the second sub-portion, and reducing the size of the first sub-portion based on the consistency metric.

3. The method of claim 2, further including computing the consistency metric by computing the Euclidian distance between the first and third objects of interest.

4. The method of claim 3, further including comparing the consistency metric with a pre-set consistency threshold to determine whether the first and third objects of interest are substantially similar.

5. The method of claim 1, wherein the second sub-portion encompasses a second object of interest, and further including presenting the first and second sub-portions corresponding to the first and second sub-portions at which the first and third objects of interest are substantially similar.

6. The method of claim 5, wherein the presented first and second sub-portions have a size that includes enough anatomical content to unambiguously register the first sub-portion with the second sub-portion.

7. The method of claim 1, wherein the first and third sub-portions are volumes of interest.

8. The method of claim 1, wherein the size of the first sub-portion is reduced by a fixed percentage.

9. The method of claim 1, further including using a volume preserving registration in which only one or more of translation, orientation and scaling are employed to register the sub-portions.

10. The method of claim 1, wherein the second sub-portion encompasses a second object of interest, and further including optimizing a similarity measure between image values in the first and second sub-portions and images values in the second and third sub-portions.

11. The method of claim 1, wherein the object of interest is a tumor.

12. An image registration system, comprising:
a registration component that registers a first volume of interest of a first image with a corresponding second volume of interest of a second image and reverse registers the second volume of interest of the second image with a corresponding third volume of interest of the first image, wherein the first volume of interest includes a first object of interest and the third volume of interest includes a third object of interest;
a consistency determining component that determines a consistency value between the first and third objects of interest, wherein the consistency value is indicative of the similarly between the first and third objects of interest; and
a decision component that determines whether a size of the first volume of interest is reduced based on the consistency value.

13. The system of claim 12, wherein the decision component compares the consistency value with a consistency threshold to determine whether the size of the first volume of interest is reduced.

14. The system of claim 12, wherein the consistency value is a Euclidian distance between the first and third objects of interests, and the Euclidian distance is normalized over a total number of voxels used to determine the consistency value.

15. The system of claim 12, wherein the size of the first volume of interest is reduced by a fixed volume.

16. The system of claim 12, wherein the consistency value is based on at least one of correlation, root mean square deviation, or mutual information to register the volumes of interest.

17. The system of claim 12, further including weighting contributions from the volumes of interest with weights that decrease from a center of the volumes of interest to a periphery of the volumes of interest.

18. The system of claim 12, wherein the registration component employs one of an exhaustive, a stochastic, or a Gauss-Newton registration.

19. A method, comprising:
iteratively reducing a size of a volume of interest in a first image until a consistency error between a forward and a reverse registration of the volume of interest between a first and second image becomes greater than a consistency error threshold; and
presenting a first volume of interest of the first image and a second volume of interest of the second image, wherein the first and second volumes of interest have a size that corresponds to a size of the volume of interest at which the consistency error between the forward and the reverse registration was less than the consistency error threshold.

20. The method of claim 19, wherein the first and second volumes of interest include enough anatomical content to unambiguously register the first and second volumes of interest so that a first object of interest in the first volume of interest substantially maps to a second object of interest in the second volume of interest, wherein the first and second objects of interest correspond to a same anatomical structure.
